(19) United States
(12) Patent Application Publication
(10) Pub. No.: US 2006/0070812 A1
(43) Pub. Date: Apr. 6, 2006

(54) Battery-operated grease gun

(76) Inventor: Jerry W. Eggleton, Jacksonville Beach, FL (US)

Correspondence Address: RICHARD L HUFF, 19304 OLNEY MILL ROAD, OLNEY, MD, 20832, US

(21) Appl. No.: 11/208,162

(22) Filed: Aug. 22, 2005

Related U.S. Application Data
(60) Provisional application No. 60/612,570, filed on Sep. 24, 2004.

(51) Int. Cl. F16N 21/00

(52) U.S. Cl. 184/105.2

(57) ABSTRACT

A device which changes rotational movement into reciprocal movement. The device contains a final drive gear and a drive pin is eccentrically mounted on the surface of the final drive gear and is connected to a sliding block, the sliding block is connected to a yoke, the yoke is connected to a slide box, and the slide box is connected to a piston. Needle bearings fit within rounded notches in the outer walls of the yoke and abut with the inner walls of the slide box resulting in a minimum of friction between the yoke and the slide box. Also, a sliding block is present inside the yoke and needle bearings are present between the drive pin and the sliding block and between the sliding block and the yoke to reduce friction between the drive pin and the sliding block and the sliding block and the yoke, respectively.

### CROSS-REFERENCE TO RELATED APPLICATIONS

This application claims the benefit of the priority date of applicant's provisional application, Ser. No. 60/612,570, filed Sep. 24, 2004.

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the Invention

The field of this invention is that of grease guns in which the grease is forced through outlet valves which are opened and closed by reciprocating pistons. The invention is in an improved linkage between the rotating shaft connected to a battery-powered motor and the reciprocating pistons.

2) Description of the Related Art

The most closely related prior art known to the inventor is U.S. Pat. No. 5,609,274, issued to Shih et al Mar. 11, 1997, and U.S. Pat. No. 6,135,327, issued to Post et al Oct. 24, 2000. Each of the patents shows a battery-operated grease gun having a grease-holding compartment from which grease is dispensed under pressure when a valve is opened. There is a battery-operated motor which is the source of rotational movement of a shaft and a linkage mechanism which changes the rotational motion of the shaft to reciprocal motion of a piston to cause the opening and closing of the outlet valve. Each of these patents teaches a change from rotational movement to reciprocal movement with a linkage system which includes a push piston, a yoke mounted in a slide box, and a drive pin which is eccentrically placed on a cylindrically shaped piece which rotates when the motor is on. The drive pin fits inside a slot in the yoke and forces the yoke to move in a reciprocal manner within the slide box when the cylindrically shaped piece is rotated.

The Shih et al patent is silent as to any mechanism to minimize friction between the yoke and either the wall of the slide box or the drive pin. The Post et al patent relies upon lubrication to reduce friction and the noise and wear that accompany it.

### BRIEF SUMMARY OF THE INVENTION

The object of the present invention is to bring about a minimum of friction between the yoke and the slide box, between the yoke and the sliding block, and between the sliding block and the drive pin. This is done by the use of needle bearings between the yoke and the wall of the slide box, between the inner wall of the yoke and the sliding block, and between the sliding block and the drive pin.

In the present invention friction between the yoke and the slide box is minimized by the presence of a plurality of needle bearings located between the wall of the slide box and the yoke. These bearing allow for the free passage of the yoke along the walls of the slide box with a reduced amount of noise and wear.

Friction between the yoke and the drive pin is reduced by placing the drive pin within a sliding block wherein there are needle bearings between the drive pin and the sliding block and there are needle bearings between the sliding block and the wall of the slot in the yoke.

### BRIEF DESCRIPTION OF THE SEVERAL VIEWS OF THE DRAWINGS

FIG. 1 is a side elevational view of a battery-operated grease gun showing the basic parts of the grease gun.

FIG. 2 is an elevational exploded view of a grease gun of this invention.

FIG. 3 is an elevational front cutaway sectional view of the linkage mechanism of the grease gun according to the present invention.

### DETAILED DESCRIPTION OF THE INVENTION

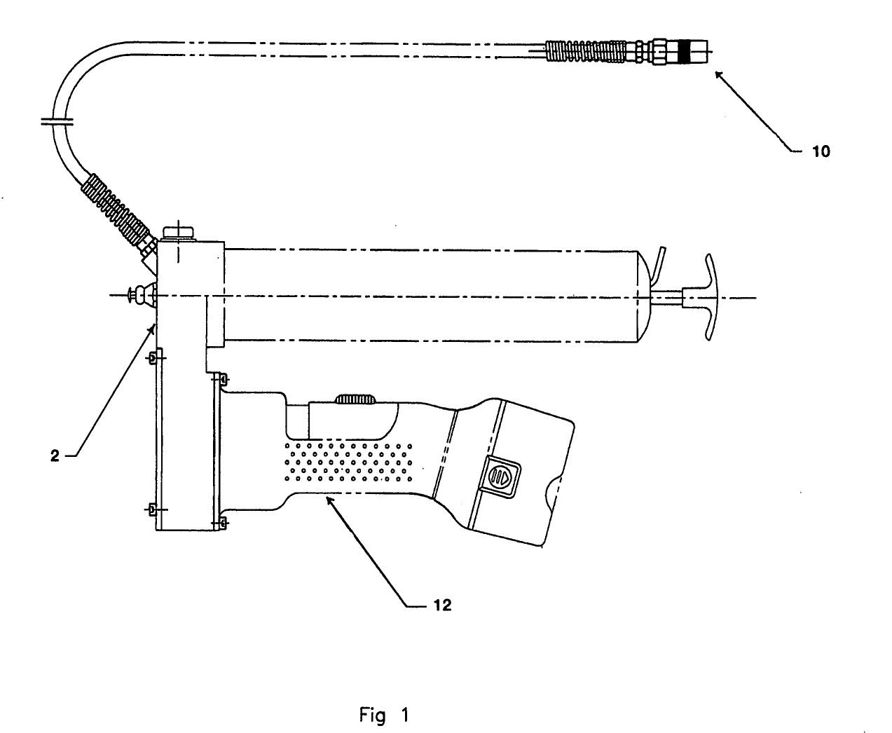

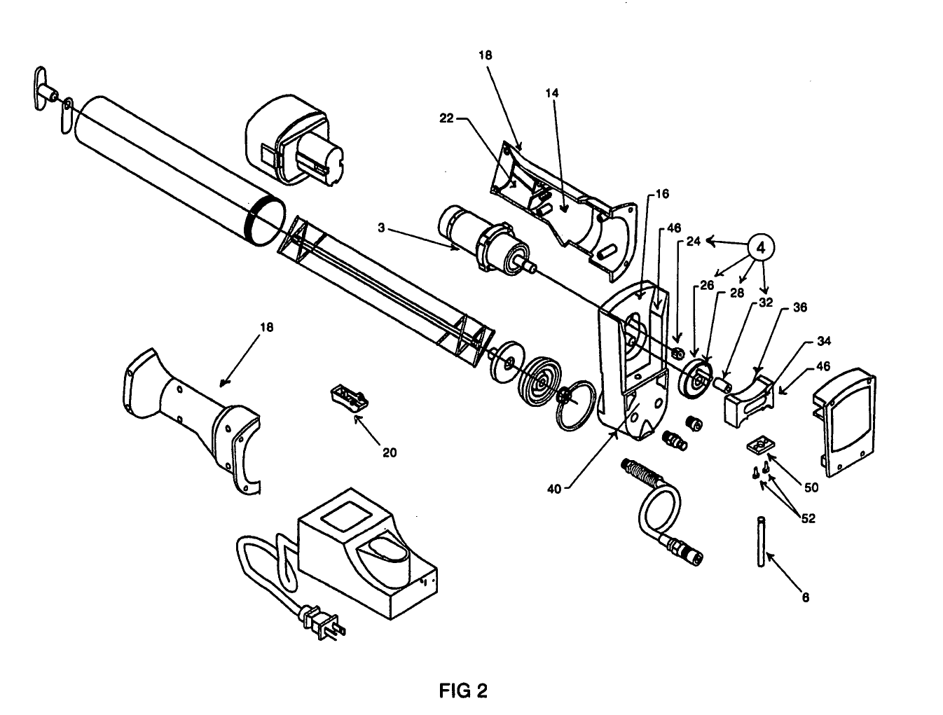

The battery-operated grease gun 2 of the present invention is shown in FIGS. 1 and 2. The grease gun 2 basically comprises an electric motor 3 that drives a power transmission system 4 that in turn drives a piston 6 that opens and closes an outlet valve 8 to discharges grease under pressure through a discharge spout 10. These component parts are contained in or mounted on a housing 12.

The housing 12 in the preferred embodiment is constructed of plastic as is typical in many prior art battery-operated grease guns. The housing 12 is constructed of several housing parts that are held together by fasteners (not shown), as also is conventional. The housing 12 is constructed with an electric motor compartment 14 and transmission compartment 16. The grease gun 2 contains a manual handle 18 which contains a trigger 20. The grease gun 2 further contains a battery compartment 22 which holds one or more batteries (not shown) in its interior.

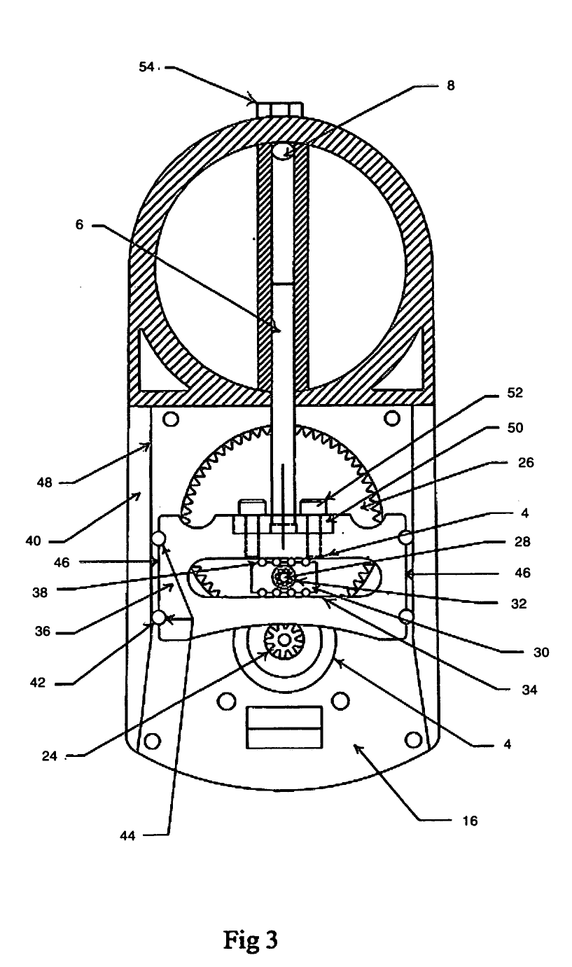

The improved linkage of the present invention is shown in FIG. 3. Operation of the motor results in the rotation of the first, small gear 24. In order to reduce the speed, the first, small gear 24 is operationally connected to a second, final drive gear 26 which is considerably larger than the first, small gear 24. The second, final drive gear 26 freely rotates about its axis (not shown) with the use of needle bearings (not shown).

A drive pin 28 is eccentrically mounted on the surface of the final drive gear 26 in such a way that the rotation of the final drive gear 26 causes the drive pin 28 to travel in a circular path in which the radius of the circle is equal to the distance from the center of the drive pin 28 to the center of the axis of the final drive gear 26.

The drive pin 28 lies inside a sliding block 30 and is separated from the sliding block 30 by needle bearings 32. In this manner, as the final drive gear 26 turns, the drive pin 28 and sliding block 30 travel in a circular path but the sliding block 30 will maintain a constant orientation with respect to the surrounding elements.

The drive pin 28 and sliding block 30 are located in a slot 34 within a yoke 36. A plurality of needle bearings 38 fits between the sliding block 30 and the inner walls of the slot 34. Because of the needle bearings 32 between the drive pin 28 and the sliding block 30 and the needle bearings 38 between the sliding block 30 and the walls of the slot 34 of the yoke 36, very little friction with the accompanying noise and wear is produced during operation of the grease gun 2.

The yoke 36 fits within the slide box 40 and is separated from the walls of the slide box 40 a slight distance. Needle bearings 42 fit within rounded notches 44 in the outer walls 46 of the yoke 36 and abut with the inner walls 48 of the slide box 40. These bearings 42 enable freedom of movement of the yoke 36 within the slide box 40 with a minimum of friction.

The yoke 36 is connected to a piston 6 with the use of a piston plate 50 and piston plate retaining bolts 52. The piston 6 is connected to a conventional ball check valve assembly 54 to open and close the outlet valve 8 of the grease gun 2.

The mechanism connecting the small gear 24 of the motor with the piston 6 may find uses in devices other than grease guns. It may be used to reduce the production of friction in any apparatus wherein rotational movement is converted to reciprocal movement.

Although the invention has been described and illustrated in detail, it is to be clearly understood that the same is by way of illustration and example, and is not to be taken by way of limitation. The spirit and scope of the present invention are to be limited only by the terms of the appended claims.

I claim:

1. In a device which, when operated, results in the rotation of a final drive gear and a drive pin is eccentrically mounted on the final drive gear in such a way that the rotation of the final drive gear causes the drive pin to travel in a circular path, the drive pin is operatively connected to a sliding block, the sliding block is operatively connected to a yoke having inner and outer walls, the yoke travels reciprocally within a slide box having walls, and the yoke is operatively connected to a piston so that circular movement of the drive gear causes reciprocal movement of a piston, the improvement comprising: a sliding block is present inside the yoke and needle bearings are present between the drive pin and the sliding block to reduce friction between the drive pin and the sliding block.

2. The device of claim 1, wherein needle bearings are present between the sliding block and the inner walls of the yoke.

3. In a device which, when operated, results in the rotation of a final drive gear and a drive pin is eccentrically mounted on the final drive gear in such a way that the rotation of the final drive gear causes the drive pin to travel in a circular path, the drive pin is operatively connected to a sliding block having walls, the sliding block is operatively connected to a yoke having inner and outer walls, the yoke travels reciprocally within a slide box having walls, and the yoke is operatively connected to a piston so that circular movement of the drive gear causes reciprocal movement of a piston, the improvement comprising: needle bearings fit within rounded notches in the outer walls of the yoke and abut with the inner walls of the slide box resulting in reduced friction between the yoke and the slide box.

4. The device of claim 3, wherein a sliding block is present inside the yoke and needle bearings are present between the drive pin and the sliding block to reduce friction between the drive pin and the sliding block.

5. The device of claim 3, wherein needle bearings are present between the sliding block and the inner walls of the yoke to reduce friction between the sliding block and the inner walls of the yoke.

6. In a battery-powered grease gun comprising a final drive gear and a drive pin is eccentrically mounted on the final drive gear in such a way that the rotation of the final drive gear causes the drive pin to travel in a circular path, the drive pin is operatively connected to a sliding block having walls, the sliding block is operatively connected to a yoke having inner and outer walls, the yoke is operatively connected to a slide box, and the slide box is operatively connected to a piston so that circular movement of the drive gear causes reciprocal movement of a piston, the improvement comprising: needle bearings fit within rounded notches in the outer walls of the yoke and abut with the inner walls of the slide box resulting in a minimum of friction between the yoke and the slide box.

7. The grease gun of claim 6, wherein needle bearings are present between the sliding block and the inner walls of the yoke.

8. The grease gun of claim 6, wherein a sliding block is present inside the yoke and needle bearings are present between the drive pin and the sliding block to reduce friction between the drive pin and the sliding block.
